(19) United States
(12) Patent Application Publication
(10) Pub. No.: US 2022/0356867 A1
(43) Pub. Date: Nov. 10, 2022

(54) METHOD FOR OPERATING A WIND POWER INSTALLATION, WIND POWER INSTALLATION AND WIND FARM

(71) Applicant: Wobben Properties GmbH, Aurich (DE)

(72) Inventors: Johannes FROMMANN, Hamburg (DE); Enno VON ASWEGE, Grossefehn (DE); Christian SCHULTE, Filsum (DE)

(21) Appl. No.: 17/735,885

(22) Filed: May 3, 2022

(30) Foreign Application Priority Data
May 4, 2021 (EP) 21172083.4

(51) Int. Cl. F03D 7/02; F03D 7/04; F03D 17/00

(52) U.S. Cl. CPC F03D 7/0264; F03D 7/042; F03D 17/00; F05B 2270/32; F05B 2270/327; F05B 2270/328; F05B 2270/331; F05B 2270/342; F05B 2270/70; F05B 2270/1095

(57) ABSTRACT

The present disclosure relates to a method for operating a wind power installation, in particular for identifying unusual oscillation events, and an associated wind power installation and a wind farm. The method comprises the steps of: providing a parametrized limit for a value of an observed oscillation of a component of the wind power installation; determining a current limit from the parametrized limit taking account of at least one current ambient parameter, in particular an ambient parameter that is indicative for the current incident flow; determining a current value of the observed oscillation of the component; comparing the current value of the observed oscillation of the component with the current limit; and operating the wind power installation on the basis of the result of the comparison.

### BACKGROUND

### Technical Field

The present disclosure relates to a method for operating a wind power installation, an associated wind power installation, and an associated wind farm.

### Description of the Related Art

Wind power installations are well known. They serve to convert energy contained in the wind into electrical energy. Wind power installations are most commonly what are known as horizontal axis wind power installations, in the case of which a rotor with one or more rotor blades, which rotates about a substantially horizontal axis, is disposed on a tower.

Wind power installation control is very complex since very different operating manipulated variables are interrelated and react, sometimes sensitively, to highly dynamic ambient conditions. For example, the occurrence of gusts may lead to a critical increase in the operating loads since the aerodynamically acting rotor blades suddenly generate significantly larger aerodynamic forces.

The occurrence of certain oscillation events, for example in relation to the tower head of the wind power installation, is unavoidable in this case. One of the challenges lies in correctly identifying an operating state or an imminently upcoming operating state in order to adopt the correct open-loop or closed-loop control measures.

Expressed differently, a challenge lies in distinguishing between an expected or usual oscillation and an unusual or unwanted oscillation.

The use of simulations to predict expected oscillations and dynamic loads for wind power installations is known. However, experience has taught that deviations sometimes arise between simulation and reality. These deviations which lead to oscillations, partly of unknown or, within the control, unconsidered origin, may have a negative influence on the service life of the wind power installation.

### BRIEF SUMMARY

Provided are methods to improve the operation of a wind power installation, in particular to improve the recognition of unusual oscillations.

One aspect proposes a method for operating a wind power installation, in particular for identifying unusual oscillation events. The method comprises the steps of:
providing a parametrized limit for a value of an observed oscillation of a component of the wind power installation, the component being at least one of a tower head, a rotor blade, a generator, and a rotor,
determining a current limit from the parametrized limit taking account of at least one current ambient parameter, in particular an ambient parameter that is indicative for the current incident flow,
determining a current value of the observed oscillation of the component,
comparing the current value of the observed oscillation of the component with the current limit, and
operating the wind power installation on the basis of the result of the comparison.

A parametrized limit is not constant for all values of the ambient parameter but yields a different value, referred to as current limit, for at least two different values of the ambient parameter. In one example, the parametrized limit may be a function of the ambient parameter and, optionally, further parameters, and may be calculated analytically from the ambient parameter and, optionally, the further parameters. In other examples, the parametrized limit may be stored in a table, with an associated limit being stored in the table for each value of the ambient parameter or for a respective value range of the ambient parameter.

The parametrized limit may be stored directly in an installation controller of the wind power installation, for example saved or securely soldered, or it may be provided to the wind power installation, for example via a data communications link, from a further unit, for example a server on the Internet.

All combinations of local and remote provision and evaluation of data are conceivable within the scope of this disclosure.

Likewise, the current limit from the parametrized limit can therefore be determined from the current ambient parameter, for example locally at the wind power installation or by means of a remote unit.

By way of example, the current ambient parameter may be measured by the wind power installation itself. In other embodiments, the current ambient parameter may also be provided from other sources, for example be contained in metrological data, which are indicative for the incident flow, or be determined by a measuring device, for example a measuring mast, in the surroundings of the wind power installation.

All component parts and assemblies which are able to be delimited structurally or functionally are understood to be a component of the wind power installation. These comprise a rotor blade, a rotor, a generator, a nacelle and/or a tower head, without being restricted thereto.

It turns out that it is not easy to determine a limit for classifying usual and unusual oscillation events. Thus, a value of an observed oscillation may be usual in one operating state while the same value of the observed oscillation is unusual in another operating state. As a consequence, a fixedly prescribed limit may lead either to too little sensitivity or to too little specificity, depending on how high the limit is set.

The present disclosure now is able to provide the limit in such a way that the latter increases the reliability of the classification, that is to say the sensitivity and the specificity. This is achieved by virtue of providing a limit that is parametrized by the incident flow. Trials have shown that there is a very good correlation especially between the incident flow and expected oscillations, with higher oscillations usually being usual in the case of a higher incident flow. Expressed differently, the parametrized limit will also supply a higher value as current limit for higher values of the incident flow in one example.

Finally, the term “operating” is interpreted broadly within the scope of the present disclosure and comprises both wind power installation control and communication or disclosure of events. In a preferred embodiment, this is the notification of an unusual oscillation event so that the latter can then be checked manually by a member of staff, for example by way of remote maintenance. Accordingly, operating comprises all aspects occurring within the scope of the operation of the wind power installation.

Preferably, the value of the observed oscillation is a value that characterizes the oscillation or a value derived therefrom, including an acceleration, a maximum oscillation deflection or a frequency component.

Other examples of the value of the observed oscillation include mean values over predetermined periods of time and/or oscillation periods, or other geometric parameters that are derived from a measurement signal, for example derivatives, absolute values, etc. Combinations of the values are also conceivable.

Preferably, the ambient parameter comprises a wind speed, the wind speed being measured and/or determined by way of a wind estimator from a current operating point of the wind power installation.

What is decisive for the choice of the ambient parameter is that the latter exhibits good correlation with the observed oscillations or accelerations. In this case, it is irrelevant whether the ambient parameter is measured directly or whether use is made of an installation characteristic that has a high correlation with the ambient parameter, for example wind estimation/wind measurement. Thus, in particular, it must be possible to establish a unique mapping between the ambient parameter and the incident flow/wind speed.

In the case of a sufficient accuracy, the ambient parameter may also be provided by other units, which differ from the wind power installation. By way of example, these other units are meteorological measuring masts, other wind power installations, satellite data, etc. There is sufficient accuracy if the ambient parameter obtained provides a reliable statement about the state at the wind power installation. Each ambient parameter provided by another unit is preferably sufficiently accurate to this end if, on average, it has an error of less than 20%, in particular less than 10%, in relation to the actual ambient parameter at the wind power installation, this being verifiable by measurements when in doubt.

In further preferred configurations, the ambient parameter additionally comprises further wind properties, including shear, air density and/or turbulence intensity, etc.

Preferably, the wind speed has a reference time period of no more than 1 minute, in particular between 10 and 30 seconds and particularly preferably 10 seconds.

It turned out that the time period of 10 seconds, in particular, exhibits a particularly high correlation quality. Shorter and longer time periods are also possible in this context, a time period of 1 minute having been found to be upper limit for the reference time period. Longer reference time periods do not have a sufficiently precise resolution that allows unusual oscillation events to be identified.

The value of the observed oscillation is preferably measured on the component. To this end, a suitable measurement recording device, in particular, is in direct or indirect contact with the component in order to record the oscillation spectrum or accelerations.

Preferably, the measurement is carried out using at least one of, preferably several of, an acceleration sensor, a gyroscope, an incremental encoder, a strain measurement, an optical sensor and/or a power measuring device.

By way of example, an acceleration sensor may be disposed in a tower head, that is to say an upper region of the tower, and optionally additionally throughout the tower. To this end, the acceleration sensor may have a one- or multi-dimensional embodiment and accordingly record oscillations or accelerations in one or more dimensions. The oscillations in a plurality of dimensions may be evaluated individually or may be combined, for example summated.

By way of example, a gyroscope is disposed on a co-rotating part of the hub and may also facilitate a rotational speed measurement, for example. A gyroscope may also be provided in the stationary system, for measuring tilts and/or higher oscillation modes of the tower.

A path/angle measurement at the blade connection can be implemented by means of an incremental encoder, for example. To observe an oscillation, such a measurement may comprise, for example, a resolution of at least 0.1° in space and 10 ms (milliseconds) in time, with other resolutions, in particular higher resolutions, also being conceivable.

A strain measurement may be implemented at the foot of the tower and/or at a blade connection of the rotor blade, for example, using a strain gauge or other sensors. In the first case, this can be used to observe tower oscillations and in the second case the strain measurement is suitable for determining blade bending moments.

In further embodiments, optical measuring methods are preferred, for example from fos4x or BladeVision, for example for observing blade bending by way of reflection.

Power measurements, for example of a transformer and/or the mains power, are preferred in further embodiments.

Preferably, the value of the observed oscillation is derived from measurements on a component of the wind power installation that differs from the observed component. Thus, this embodiment represents an alternative to the direct measurement on the component.

Preferably, the observed component is the rotor of the wind power installation and a current value of the oscillation of the rotational speed of the rotor is derived from the generator current.

Preferably, the component of the wind power installation whose value of an oscillation is observed comprises one or more of the following components:
a tower head, with a tower head acceleration, in particular, being observed,
a rotor blade, with oscillations of a pitch angle and/or swivel load of the rotor blade, in particular, being observed,
a generator, with oscillations of a generated power of the generator, in particular, being observed, and
a rotor, with oscillations of a rotational speed of the rotor, in particular, being observed.

Preferably, in the case where a tower head acceleration of the tower head is observed, the step of comparing the current tower head acceleration with the current limit comprises:
a filtering, in particular a low-pass filtering, of the tower head acceleration in order to observe components of the tower head acceleration of preferably no more than 0.8 Hz, and/or
a determination of an extremal point of the tower head acceleration, the determined extremal point of the tower head acceleration being compared with the limit, and/or
a determination of a mean amplitude of the tower head acceleration, the determined mean amplitude being compared with the limit.

The determination of an extremal point preferably is a local determination of an extremal point, within the scope of which the extremal point is determined during a specified observation time period. The specified observation time period is preferably no shorter than 2 s (seconds) and preferably no longer than 10 s.

Preferably, the mean amplitude can be determined over a certain number of cycles of oscillation cycles of the tower, the certain number of cycles particularly preferably ranging from 10 to 30 cycles. Towers are known to usually have a low first eigenfrequency of 0.15 Hz (Hertz), for example. The number of cycles and/or a time limit for averaging is particularly preferably chosen on the basis of the first eigenfrequency of the tower of the wind power installation.

Particularly preferably, the number of cycles is adjustable on the basis of the tower eigenfrequency. This was found to be particularly advantageous in the case of transverse oscillations in particular, since a decay time component of the transverse oscillations depends on the eigenfrequency and so unexpected transverse oscillations are only detected when averaging over a suitably chosen number of cycles.

Particularly preferably, different limits are provided for the case where the extremal point of the tower head acceleration is determined and for the case where the mean amplitude is determined.

Thus, every oscillation component of for example less than 0.8 Hz remains in the measurement signal when monitoring the tower oscillations. A singular high oscillation can be detected by determining the extremal point, with the mean amplitude or sliding average of the extremal values also being evaluable. In particular, the evaluation requires no spectral evaluation. However, the spectrum of the oscillation may also be evaluated in addition to the classification in further configurations.

Preferably, in the case where oscillations of a pitch angle of the rotor blade are observed, the step of comparing the current oscillation of the pitch angle with the current limit comprises a filtering, in particular a high-pass filtering, of the current oscillation of the pitch angle in order to eliminate wind-excited oscillations.

Accordingly, wind-excited oscillations can be eliminated by filtering, in particular high-pass filtering, of the pitch angle. Therefore, the remaining components are of greater relevance to unusual oscillations. By way of example, a value of 0.05 Hz is conceivable as a cut-off frequency for the high-pass filtering, with other values also being conceivable. Other types of filtering are also advantageous in other embodiments.

It turns out that the use of a mean pitch angle is advantageous in the case of single blade adjustments, within the scope of which therefore the pitch angles of the different rotor blades in any case contain an individual component. In this case, the mean pitch angle preferably denotes a mean or an average over the simultaneously present pitch angles of the individual rotor blades, and hence preferably does not denote averaging over time. This is because the individual blade adjustment itself causes an additional 1p oscillation component, which is however substantially cancelled in the mean pitch angle.

Preferably, in the case where oscillations of a pitch angle of the rotor blade are observed, the step of comparing the current oscillation of the pitch angle with the current limit additionally or alternatively comprises a distinction being made between singular events, in particular singular overshoots of the current limit, and prolonged events.

In this configuration, the wind speed dependence is given by the blade sensitivity, which increases with increasing pitch angle. By way of evaluation, the method according to the disclosure facilitates an identification of singular and prolonged oscillation events. By way of example, singular overshoots of the current limit can be traced back to control interventions or interventions of a controller for avoiding extreme loads.

By way of example, prolonged overshoots can be traced back to unexpected controller resonances or a rotational speed oscillation being coupled into the rotational speed control, which may have a tower transverse oscillation as a consequence.

Preferably, in the case where oscillations of a swivel load of the rotor blade are observed, the step of comparing the current oscillation of the swivel load with the current limit comprises a compensation of an oscillation contribution whose frequency corresponds to the rotor rotation and corresponds in terms of absolute value to the gravitational contribution.

Compared to filtering out the 1p oscillations, this implementation is advantageous in that only the gravitational contribution, which acts with 1p, is removed by calculation but the 1p oscillations having a different cause remain in the spectrum. Hence, the result of this removal by calculation directly is the structure oscillation, which can be checked in relation to a usual or unusual oscillation. Preferably, general filtering, for example offset-free high-pass filtering, may additionally be applied in this case.

Preferably, in the case where oscillations of a power generated by the generator are observed, the step of comparing the current oscillations in the generated power with the current limit comprises a filtering, in particular a high-pass filtering, of the generated power in order to eliminate wind-excited oscillations.

Preferably, in the case where oscillations of a power generated by the generator are observed, the step of comparing the current oscillations in the generated power with the current limit alternatively or additionally comprises compensating power changes induced by controlling the wind power installation.

The power is defined as wind-excited up to a maximum of 0.1 Hz, which is also referred to as wind turbulence. As a result of the filtering, in particular high-pass filtering, only higher-frequency and therefore, in essence, unexpected oscillations remain in the spectrum. If for example wanted power oscillations—such as those induced power changes for reducing tower oscillations—are subtracted, all that still remains is an unexpected frequency spectrum.

The power signal is preferably evaluated as a moving average such that a lower threshold in comparison with an evaluation of an extremal value is facilitated. This can mainly be traced back to the fact that the moving average is more robust and less susceptible to short-term variations. Consequently, even minor but prolonged unexpected oscillation amplitudes in the power are identifiable in this example.

In conjunction with this disclosure, an average or mean may be realized as an arithmetic mean, for example. In other embodiments, characteristics other than the average or mean are also suitable for the central tendency of a distribution, for example the geometric mean or the root mean square.

Preferably, in the case where oscillations of a rotational speed of the rotor are observed, the step of comparing the current rotational speed of the rotor with the current limit comprises a filtering, in particular a high-pass filtering, of the observed rotational speed in order to eliminate wind-excited oscillations.

Preferably, the method further includes the steps of:
determining, in particular simulating, an expected operating load of the wind power installation during normal operation,
comparing the expected operating load of the wind power installation with a measured actual load of the wind power installation and
adjusting the parametrized limit on the basis of the comparison.

Accordingly, the individual case of the installation can be considered for service life considerations, for example, according to this embodiment. Should the actual wind power installation be determined to deviate during operation from what was determined for this wind power installation, for example by way of a simulation, then the actually occurring loads are greater than the loads determined in advance. Naturally, the converse is also possible, specifically if the loads are lower than expected.

In a preferred development, the load reserve forming in this case or the excess loads can be used to adjust the system management. By way of example, load reserves might be used to increase possibly present power reserves of the wind power installation in the case of a sufficient wind.

However, if an unexpected high load is experienced in the wind power installation, for example as a result of unexpected wind conditions such as greater shear and/or turbulence, this offers the option of adjusting the system management in view of reducing the loads.

Preferably, the adjustment of the parametrized limit further comprises an increase in the parametrized limit by a predetermined increase factor should the parametrized limit have been exceeded.

Preferably, the adjustment of the parametrized limit further alternatively or additionally comprises a reduction in the parametrized limit by a predetermined reduction factor should the parametrized limit not have been exceeded over a predetermined period of time.

The increase factor and/or the reduction factor can, as a factor, be relative to the parametrized limit, for example between 0 and 200%. Particularly preferably, the increase factor and/or the reduction factor also depends on the wind speed such that this may allow a different increase factor and/or reduction factor at higher wind speeds than at lower wind speeds.

The predetermined time period is preferably at least one hour and likewise preferably no more than 10 days. Particularly preferably, the predetermined time period is approximately or exactly 1 day.

Preferably, the step of operating the wind power installation on the basis of the result of the comparison further includes the following steps:
detecting an unusual oscillation event when the current value of the observed oscillation overshoots or undershoots the current limit, and
communicating the detected unusual oscillation event, in particular by way of SCADA (supervisory control and data acquisition).

The communication, by way of example by way of SCADA, may also comprise logging the relevant data, in particular relevant measurement data of the observed oscillation, or other data, for example of further measuring sensors of other components or operating characteristics.

A further aspect proposes a wind power installation comprising a controller, the controller being designed to implement the method according to the disclosure.

To this end, the controller may have for example the same components as a known installation controller of a wind power installation, including a computing unit such as a microprocessor and/or a CPU (central processing unit), and suitable storage components and interfaces. In this case, the controller is accordingly distinguished from the known controllers of wind power installations by way of the software stored thereon and/or executed thereby. In other embodiments, the method may also be implemented, in part or in full, by hardware.

The controller is split in further embodiments, with only a part of the controller being located in the spatial vicinity of the wind power installation, for example within a nacelle of the wind power installation or within a tower of the wind power installation, and further parts of the controller being implemented on a spatially remote computer unit. By way of example, the remote computer unit comprises a server which is connected to the further parts of the controller by way of the Internet.

A further aspect proposes a wind farm containing a plurality of wind power installations according to the disclosure.

The wind farm according to this aspect and the wind power installation according to the aspect described above may be combined with all preferred configurations of the disclosed method and may achieve the same advantages in the process.

### BRIEF DESCRIPTION OF THE SEVERAL VIEWS OF THE DRAWINGS

Further advantages and preferred configurations are described below with reference to the appended figures. In the figures:

FIG. 1 schematically shows a wind power installation by way of example;

FIG. 2 schematically shows a wind farm by way of example;

FIG. 3 schematically shows correlations of oscillations and ambient parameters by way of example;

FIG. 4 schematically shows correlations of oscillations and ambient parameters by way of example;

FIGS. 5a and 5b schematically show different oscillation events by way of example;

FIG. 6 schematically shows the detection of unusual oscillation events by way of example; and

FIGS. 7a and 7b schematically show the influence of an observation time period on the correlation by way of example.

### DETAILED DESCRIPTION

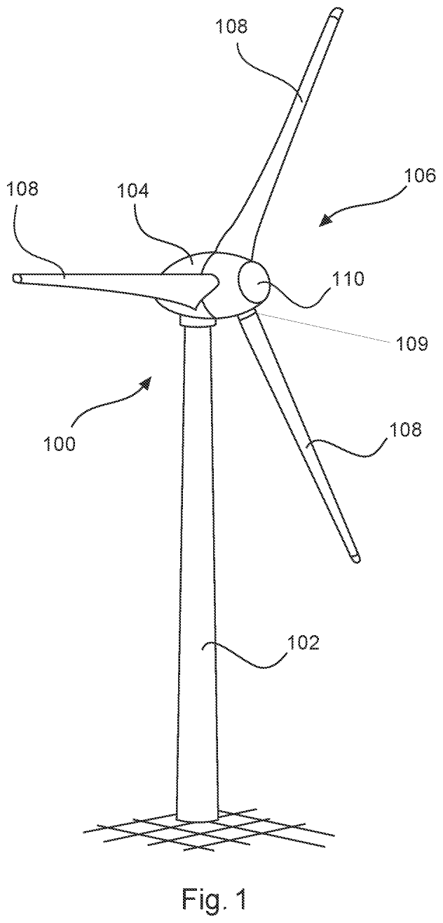

FIG. 1 shows a schematic illustration of a wind power installation according to the disclosure. The wind power installation 100 has a tower 102 and a nacelle 104 on the tower 102. An aerodynamic rotor 106 having three rotor blades 108 and having a spinner 110 is provided on the nacelle 104. During the operation of the wind power installation, the aerodynamic rotor 106 is set in rotational motion by the wind and thereby also rotates an electrodynamic rotor or armature of a generator, which is coupled directly or indirectly to the aerodynamic rotor 106. The electric generator is arranged in the nacelle 104 and generates electrical energy. The pitch angles of the rotor blades 108 may be varied by pitch motors at the rotor blade roots 109 of the respective rotor blades 108.

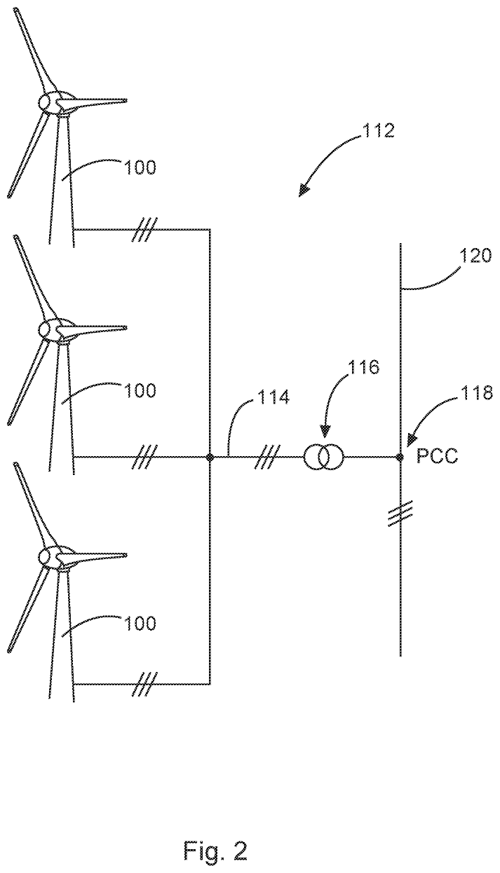

FIG. 2 shows a wind farm 112 having, by way of example, three wind power installations 100, which may be identical or different. The three wind power installations 100 are thus representative of basically any desired number of wind power installations of a wind farm 112. The wind power installations 100 provide their power, specifically in particular the generated current, via an electrical farm grid 114. In this case, the respectively generated currents or powers of the individual wind power installations 100 are added together and a transformer 116, which steps up the voltage in the farm, is usually provided in order to then feed into the supply grid 120 at the infeed point 118, which is also generally referred to as a PCC (point of common coupling). FIG. 2 is only a simplified illustration of a wind farm 112. By way of example, the farm grid 114 may also be designed in another way by virtue of for example a transformer also being present at the output of each wind power installation 100, to mention just one other exemplary embodiment.

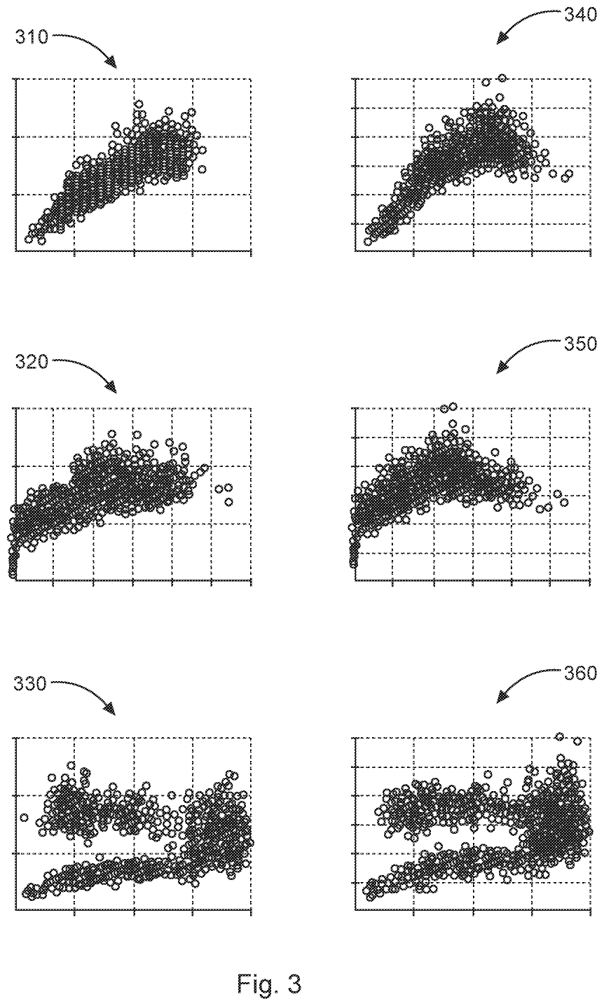

FIG. 3 schematically shows a correlation between observed oscillations of a component of the wind power plant 100 on the vertical axis and an ambient parameter on the horizontal axis by way of example. The observed oscillation in the graphs 310, 320, 330 plotted on the left is an acceleration of an upper region of the tower, also referred to as tower head, along the wind direction. In the graphs 340, 350, 360 plotted on the right, the observed oscillation is an acceleration of the mid region of the tower. The ambient parameter comprises a wind speed in graphs 310 and 340, a pitch angle in graphs 320 and 350, and a generator torque in graphs 330 and 360.

The existence of a particularly good correlation, that is to say a mapping between observed oscillation and ambient parameter that is as unique as possible, can be identified in graph 310 for the tower head acceleration and the wind speed. This likewise applies to the acceleration in the mid tower region in the graph 340. The pitch angles in graphs 320 and 350 are not unique, especially for a pitch angle of 0°. The correlation is unique for higher pitch angles. For the generator torque in graphs 330 and 360, the mapping from a moment to an acceleration is non-unique.

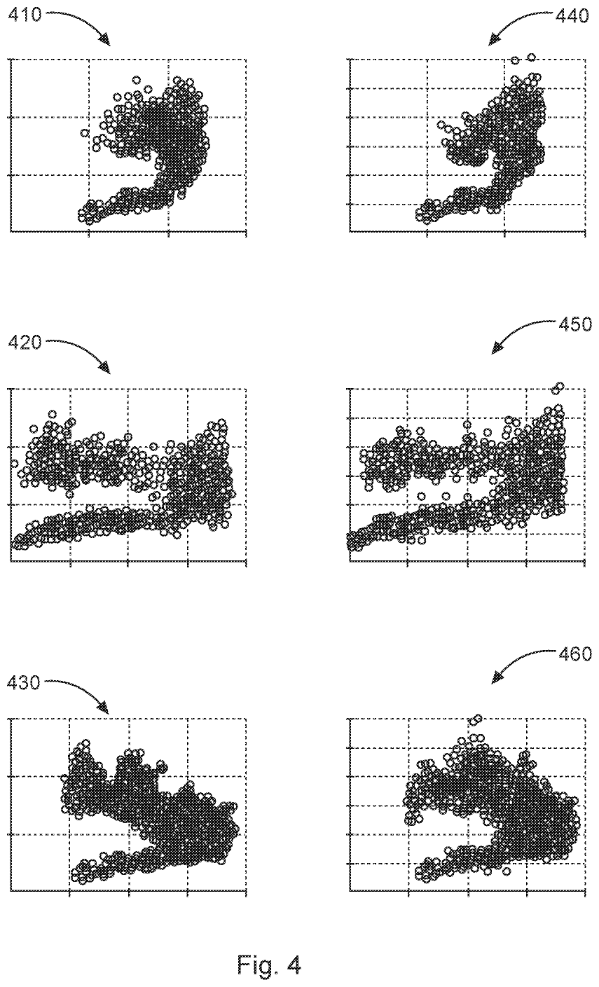

FIG. 4 shows six further graphs 410, 420, 430, 440, 450, 460, which exhibit a correlation between tower head acceleration (410, 420, 430) or acceleration in the middle of the tower (440, 450, 460) and further parameters. These values include a rotational speed in graphs 410, 440, the generated electrical power in graphs 420, 450 and a force on the rotor hub in graphs 430 and 460. None of the relationships shown in FIG. 4 exhibit a sufficient correlation for the present disclosure.

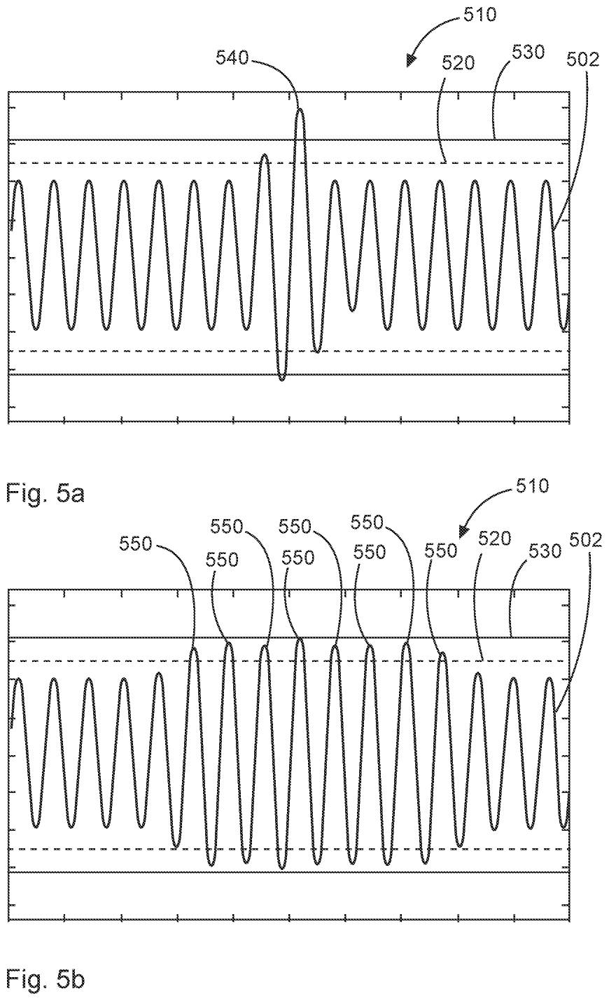

FIG. 5a schematically shows the curve of a first type of oscillation by way of example. A graph 510 shows the temporal progress of an acceleration. A dashed line is used to show a first limit 520, which for example is 25% above the average value of the oscillation. In this example, the assumption is made that the value of the oscillation 502 typically ranges between +1 and −1 m/s².

Naturally, other acceleration values and limits are also conceivable. An extremal value threshold, for example 1.6, is provided as a second threshold 530. It is evident that the oscillation 502 exceeds the second threshold 530 at one point 540. Accordingly, this is referred to as an extreme event. This means that a very high acceleration is exceeded for a brief period of time.

By contrast, FIG. 5b shows a second case of an unusual oscillation, specifically an acceleration that is above the first threshold 520 for a relatively long period of time, specifically eight periods in this example. Preferably, the limit 520 being exceeded once does not lead to the detection of such an oscillation event but the threshold 520 has to be exceeded multiple times. To this end, it is possible for example to count the number of extremal values 550 that are successively located above the threshold 520, and compare this number to a predetermined value, for example 5 or 8. Naturally, a different number of overshoots is also possible.

Note should be taken that, in contrast thereto, exceeding the threshold 530, cf. FIG. 5a, once already suffices to detect an unusual event. Combinations of the two events are also conceivable.

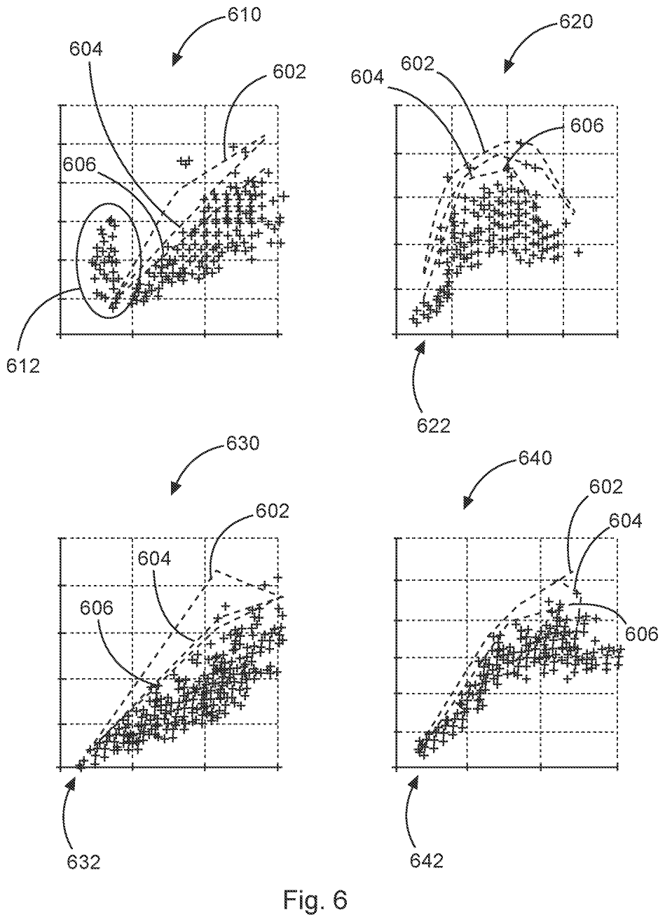

FIG. 6 schematically shows four graphs 610, 620, 630 and 640 by way of example, said graphs elucidating the identification of unusual oscillation events according to the disclosure. The wind speed is plotted along the horizontal axis in all four graphs 610, 620, 630, 640 and said wind speed is plotted against a transverse direction tower head acceleration in graph 610, a longitudinal direction tower head acceleration in graph 630, a lateral direction mid tower oscillation in graph 620 and a longitudinal direction mid tower oscillation in graph 640.

A 5 t mass imbalance at a rotor radius of 1 m was simulated and the effect on the observed oscillation was evaluated. Three different formulations of a parametrized limit 602, 604 and 606 were provided for the respective graphs. The parametrizations are based on different concepts, for example different confidence intervals or different functions. Limit 602 has been chosen more aggressively, that is to say it is only exceeded at significantly higher accelerations, whereas the further limits 604 and 606 have been formulated more conservatively so that even relatively small oscillation events that exceed the acceleration limit are rendered detectable.

Naturally, the parametrized limits 602, 604, 606 are dependent on the observed oscillation and are only labelled by the same reference symbol for the purposes of simplifying the illustration. On account of the different observed oscillations, the values of the limits 602, 604, 606 will also be different in the graphs 610, 620, 630, 640, as illustrated.

It is evident that significant overshoots of the limits 602, 604, 606 are evident only in graph 610 for the transverse direction tower head acceleration, said overshoots being grouped in a region 612. The unexpected high accelerations at low wind speeds can be traced back, as theoretically expected, to stimulation of a first tower eigenmode in the lateral direction, that is to say to a tower head oscillation.

A minor overshoot of the limits can also be detected for the X- and Y-accelerations mid tower and for the X-acceleration or longitudinal acceleration at the tower head. The corresponding points are labelled by 622, 632 and 642. By way of example, such minor overshoots can be classified as extraordinary cases.

It is evident that, for example for the case of a rotor imbalance, the transverse direction tower head acceleration in graph 610 exhibits the clearest excursions. However, minor effects can also be detected in other observed oscillations.

The method according to the disclosure therefore consists of the identification of dependencies and correlations between accelerations or speeds and ambient parameters, that is to say states of the wind power installation or the surroundings. Limit values are defined for the accelerations or oscillations of the produced electrical energy, said accelerations or oscillations depending on relevant ambient states such as the wind speed, for example. The sensitivity of the limit values in respect of various disturbances is analyzed and the defined limit values are therefore checked. Optionally, the defined limit values are adjusted, for example whenever a limit is exceeded too frequently.

Moreover, the possibility of a continuous improvement is provided since the monitoring system, once implemented, can be operated permanently on all wind power installations equipped therewith. This facilitates a permanent improvement in the determined limits, as a result of which the identification of unusual oscillation events is made permanently more precise.

Therefore, the disclosure can be divided into the following constituent parts: Initially, in a first step, suitable limits are determined and fitting dependencies are identified, for example offline. These are then compared online or in real time with current values. Finally, in a third step, there is an automatic adjustment of the previously determined limits on the basis of the actual load of the respective wind power installation, in particular also online or in real time.

For the first function, an unusual oscillation event is essentially defined by the installation operator or installation manufacturer as an oscillation that deviates from the simulation. By way of example, the oscillation that deviates from the simulation may have a stronger amplitude.

Limits are determined for the observed oscillation on the basis of simulations, for example 10 minute mean wind speeds in for example 2 m/s steps in a wind speed range from 2 to 28 m/s, the limit values naturally only being exemplary. Additionally, for example as explained above, shorter reference time periods for the wind speed, in particular of less than 1 minute, are advantageous.

Particularly preferably, the simulations model the operating load level of the wind power installation 100 during normal operation DLC 1.2 pursuant to DIN EN IEC 61400-1.

To determine the limits, use is made of the same operating values as in the installation controller itself. The maximum oscillations, for example measurements of tower oscillations, and the simultaneous wind speed, for example the wind speed obtained by a wind estimator, are read to determine the limits.

In this case, the wind speed is used as an example of an ambient parameter, with an alternative or additional use of shear and/or turbulence or further suitable ambient parameters being possible in the same way.

These are then grouped on the basis of the ambient parameter, for example the wind speed, with an increment of for example 1 m/s—once again for the wind speed—lending itself to this end. Then, a limit is determined for each of the groups of the values of the ambient parameter, for example with the aid of a quantile determination. This limit is then provided as a parametrized limit, which in this case depends on the ambient parameter such as the wind speed, for example.

In the second constituent part, the comparison of current values to limits, the obtained measurement data are filtered in particular. The operating state of the wind power installation 100 is then preferably determined, a mean, for example a moving 10 second mean, of the ambient parameter lending itself to this end. A current value and preferably also a moving mean are determined for the oscillation to be observed. In particular, the peak value of the oscillation is taken as the moving mean.

Then, the current limit is determined on the basis of the parametrized limit determined in the first constituent part, with interpolation between the points, in particular a linear interpolation, being implemented in an embodiment should there be a deviation of the current value of the ambient parameter from the granulation of the parametrized limit. This is followed by the comparison of the values to be monitored or observed with the limits.

Should a limit overshoot be detected, an information notification with the high-resolution operating measurement data can be transmitted in a preferred configuration, for example to SCADA, as a result of which it is available for analysis purposes, for example by a control engineer. The resolution of the operating measurement data is alterable and may be set to 10 Hz, for example.

A limit overshoot is an indication that the wind power installation 100 is experiencing an operating situation with increased load. The utilization moreover depends on location-specific conditions, for example. To take care of these factors that are specific to the wind power installation 100, a further adjustment of the parametrized limits in accordance with the situation is implemented. If the limit was exceeded, the limit is increased by a factor in particular; if the limit has not been exceeded for a certain period of time, the limit is accordingly reduced by a factor.

It may transpire that the present disclosure is advantageous in the real time control of a single wind power installation 100 on the basis of the measured oscillations.

The present disclosure facilitates the identification, in particular the automatic identification, of oscillation events such as tower oscillation events, which in the case of a permanent occurrence may lead to the considered material fatigue loads being exceeded. This should be identified in a timely fashion such that the option is provided to react to this and, for example, make adjustments to the control. Measures may be rectified, but are not necessarily rectified, by software; events identified in this way may also be rectified by hardware measures, for example. Preference is given for the mitigation measure to always be defined by the cause identified from this event.

Moreover, the present disclosure allows the location-specific load utilization to be estimated by using the automatically settling limit multiplier. Preferably, the limit multiplier can be extended by the introduction of the wind speed dependence, in order also to take account of a wind distribution when estimating a load utilization. Naturally, the present disclosure is also applicable to other oscillation or load measurements, for example the blade load measurement, and not restricted to the tower oscillations described in exemplary fashion.

Accordingly, the present disclosure allows the identification of an unusual oscillation event in correlation with the simultaneous operating state of the wind power installation 100, the operating state being defined in particular by wind speed, power, rotational speed and pitch angle.

The solution according to the disclosure can be implemented in a control software of the individual wind power installation 100. As a result, no additional material and/or commissioning costs arise. Preferably, the communication of unusual oscillation events with high-resolution operating measurement data is implemented automatically and in real time. Preferably, the wind power installation 100 monitoring is active at all times, for as long as the wind power installation 100 is in operation. By virtue of taking the wind speed estimated by a wind estimator as the wind speed, use is made of a characteristic in the algorithm which determines the operating state of the wind power installation 100 very well and in one dimension.

By way of example, extensions to the present disclosure include a shear and turbulence dependence. As a result, the parametrized limit can be determined even more accurately and the classification of oscillation events as usual or unusual oscillation events is refined further.

In a further configuration, summary information is generated, for example on a monthly basis. This can provide the installation operator with an overview of the state of their wind power installation 100 at regular intervals. By way of example, the report documents all unusual oscillation events detected during the report period.

Finally, in the development of the algorithm, an identification of the excitation of the observed unusual oscillation event is implemented. By way of example, this allows identification of a 1P excitation, from which it is possible to deduce that the rotor or the rotor rotation is the cause for this oscillation excitation, or the identification of a 3P excitation, which can be connected to the rotor blade transition.

The identification may contain an automatic classification of the event, for example into “already known oscillation event” or “previously unknown oscillation event.” Other classifications such as “usual” or “unusual” are also conceivable.

The oscillation monitoring may or may not prompt further steps, depending on the identification or classification of the event. By way of example, a communication or notification may be abstained from if the event is assigned a certain classification, for example if a comparable event was previously already labelled as “conventional” or “known.” In other configurations, the execution of further steps may also be coupled positively to a certain classification, and so the steps are only carried out if a certain classification result is present.

Now, further applications of the oscillation monitoring and of the disclosed method to observed oscillations are described.

In one embodiment, blade oscillations of the rotor blades in the rotor plane are observed. Edgewise blade oscillations or blade swivel loads are decisively dominated by gravitation, and hence by the 1P frequency component. This simplifies the recognition of additional unusual oscillations. The gravitation-driven 1P frequency component can either be high-pass filtered or removed by calculation using an estimate. To estimate the gravitation component, use is made, in particular, of a rotor position, a blade mass, gravitation and a center of mass of the rotor.

By way of example, if structure-dynamic vibrations are overlaid on the blade oscillations or blade swivel loads, these can be identified as a result. By monitoring the “residual load,” which essentially comprises structure resonant frequencies, it is possible to automatically identify the dominant type of oscillation.

This facilitates automated monitoring of resonant oscillations which cannot be identified directly, for example by tower oscillation monitoring. This is the case since the blade swivel load is not pronounced in the tower head oscillation, for example. An example of such an oscillation is a collective rotor swivel mode.

Pitch oscillations can be evaluated in the same way. In the case where an individual blade adjustment of the individual rotor blades is possible, a mean pitch angle, in particular, is suitable for the observation of an oscillation of the pitch angle. By way of example, pitch oscillations can be excited or impressed by a rotational speed control resonance. To eliminate wind-excited oscillations, there can preferably be high-pass filtering with a cut-off frequency of approximately 0.05 Hz, for example.

The wind speed dependence is given by the blade sensitivity, which increases with increasing pitch angle. Singular and prolonged oscillation events can be recognized, with singular oscillation events for example being able to be traced back to, or meaning, control interventions or interventions of a controller for avoiding extreme loads, and prolonged oscillation events representing for example an input coupling of a rotational speed oscillation in the rotational speed control, for example a transverse tower oscillation. Use is made of the same logic as in the case of tower oscillation monitoring.

To automatically identify a dominant type of oscillation of an identified unusual or unexpected oscillation, it is possible, for example, to carry out a frequency evaluation. The oscillation, for example the tower oscillation but any other observed oscillation, too, may have a dominant frequency depending on the structure dynamics of the wind power installation 100 and the rotational speed. One example for identifying this dominant frequency lies in a decomposition of the signal in Fourier space, for example by applying a Fourier transform to the signal, followed by grouping of the frequency ranges.

In this case, structure-dynamic and 1P frequencies, in particular, are taken into account. Subsequently, the grouped frequency spectrum is decomposed into dominant constituents, for example by way of amplitude comparisons with a mean amplitude. Whether or not one or more constituents of the decomposed spectrum are dominant is checked, for example, by comparison of the various components. In one example, a component of a frequency range may be dominant if it comprises more than a specified threshold of the entire spectrum. By way of example, a constituent may be referred to as dominant if it comprises more than 75% of the spectrum in relation to the amplitude. Naturally, this value of 75% is merely exemplary and may also be adjusted depending on the observed oscillation.

Should one or more constituents be determined as dominant, a check is finally carried out as to whether this frequency could be considered causal. In this context, the goal is to exclude, e.g., 1P excitations, which can be traced back to gravitation for example. Accordingly, the last step of the check is a plausibility test.

Even if the evaluation of the frequencies is described by way of a Fourier analysis of the signal, all further known methods for frequency analysis of the signal are naturally likewise applicable.

In a further aspect, it is possible to learn additional dependencies which lead to an increase or reduction in the parametrized limit or expected level of the observed oscillation. This includes a shear, a turbulence intensity, the wind direction, in particular on account of follow-on effects of other wind power installations, obstacles, etc. Particularly preferably, the turbulence has a dependence on the wind direction in such cases. The adjustment factor of the parametrized limit may be extended depending on for example these quantities to form a utilization factor which can be coupled to an estimate of the load utilization, in particular with an appropriate dependence on and knowledge of the wind history. In particular, the wind history comprises an occurrence frequency of wind speeds, turbulence intensities, shear, etc.

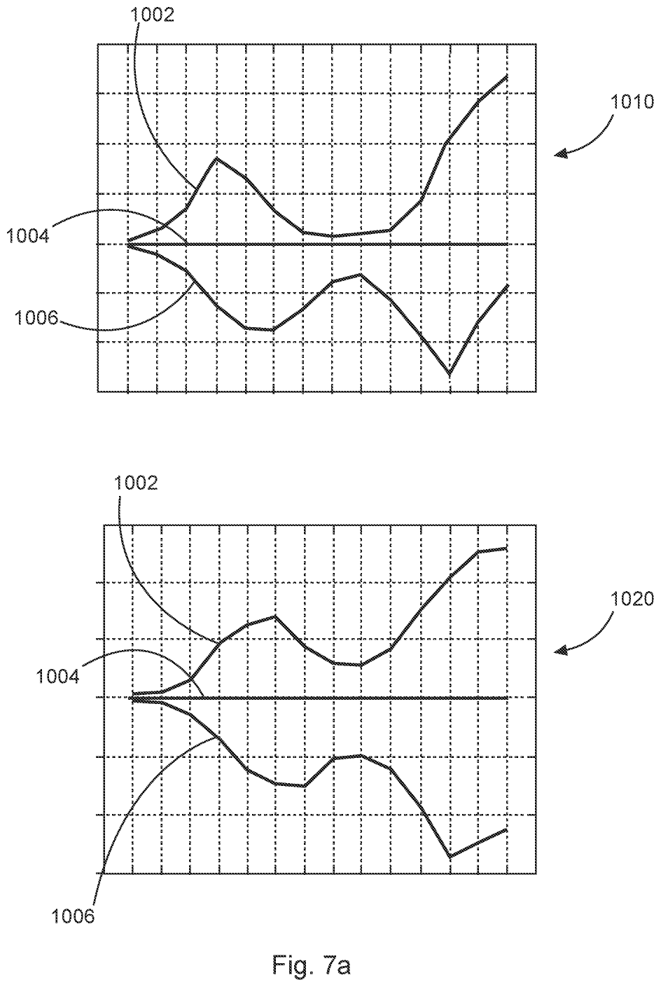

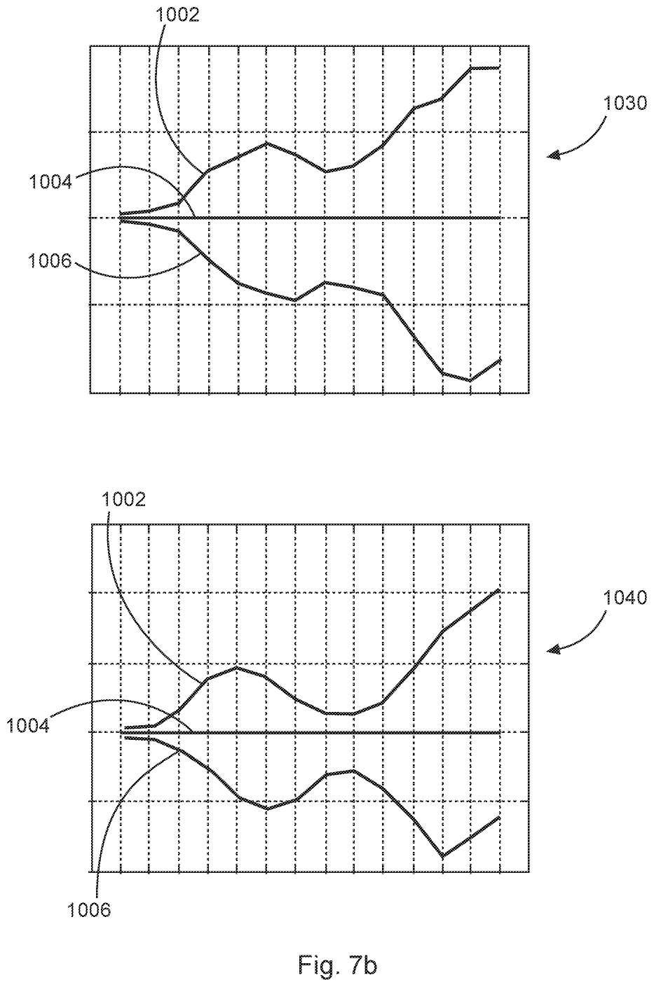

Finally, FIGS. 7a and 7b schematically show the curve of an electrical power produced by the wind power installation 100 on the vertical axis against the wind speed on the horizontal axis by way of example. In particular, the power has been high-pass filtered in order to remove the wind influence. The four graphs 1010, 1020, 1030 and 1040 differ in terms of the length of the moving average window for averaging the power. The length is 60 seconds in graph 1010, 5 seconds in graph 1020, 2.5 seconds in graph 1030 and 10 seconds in graph 1040. A maximum 1002, a mean 1004 and a minimum 1006 of the power is depicted in each case. It is evident that as the length of the moving average is increasingly reduced, a better correlation of the power variation to the wind speed is obtained. This can be seen in graph 1030 in particular.

Accordingly, singular power drops, for example on account of an insufficient power adjustment at the generator, and prolonged under- and/or over-fulfilment of the power demand, for example on account of a wrong estimate of power losses, can be identified. Accordingly, it is possible to precisely monitor the observance of a specified characteristic, for example a rotational speed-power characteristic. As a result of adjusting the transformer power, prolonged deviations should not occur in this context during normal operation.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for operating a wind power installation, the method comprising:
providing a parametrized limit for a value of an observed oscillation of a component of the wind power installation, the component being at least one of a tower head, a rotor blade, a generator, and a rotor,
determining a current limit from the parametrized limit taking into account of at least one current ambient parameter,
determining a current value of the observed oscillation of the component,
comparing the current value of the observed oscillation of the component with the current limit, and
operating the wind power installation based on the comparison.

2. The method according to claim 1, wherein the current value of the observed oscillation is a value that characterizes the observed oscillation or a value derived from the observed oscillation, including at least one of an acceleration, a maximum oscillation deflection, and a frequency component.

3. The method according to claim 1, wherein the ambient parameter comprises a wind speed, the wind speed being measured or determined by a wind estimator from a current operating point of the wind power installation.

4. The method according to claim 3, wherein the wind speed has a reference time period that is one of less than 1 minute, between 10 and 30 seconds, or less than 10 seconds.

5. The method according to claim 1, further comprising measuring the value of the observed oscillation on the component.

6. The method according to claim 5, wherein the measuring is carried out using at least one of an acceleration sensor, a gyroscope, an incremental encoder, a strain measurement, an optical sensor and a power measuring device.

7. The method according to claim 1, wherein the value of the observed oscillation is derived from measurements on a component of the wind power installation that differs from the observed component.

8. The method according to claim 7, wherein the observed component is the rotor of the wind power installation and a current value of the oscillation of the rotational speed of the rotor is derived from a generator current.

9. The method according to claim 7, wherein the component of the wind power installation is one or more of the following components:
the tower head, with a tower head acceleration being observed,
the rotor blade, with oscillations of a pitch angle and/or swivel load of the rotor blade being observed,
the generator, with oscillations of a generated power of the generator being observed, and
the rotor, with oscillations of a rotational speed of the rotor being observed.

10. The method according to claim 9, further comprising observing a tower head acceleration of the tower head, wherein comparing the tower head acceleration with the current limit comprises:
filtering using a low-pass filtering of the tower head acceleration to observe components of the tower head acceleration of no more than 0.8 Hz, and/or
determining an extremal point of the tower head acceleration, and comparing the extremal point of the tower head acceleration with the limit, and/or
determining a mean amplitude of the tower head acceleration, and comparing the mean amplitude with the limit.

11. The method according to claim 9, further comprising observing oscillations of a pitch angle of the rotor blade, wherein comparing the current oscillation of the pitch angle with the current limit comprises:
filtering the current oscillation of the pitch angle to eliminate wind-excited oscillations, and/or
making a distinction between singular events, singular overshoots of the current limit, or prolonged events.

12. The method according to claim 9, further comprising observing oscillations of a swivel load of the rotor blade, and wherein comparing the current oscillation of the swivel load with the current limit comprises a compensation of an oscillation contribution whose frequency corresponds to the rotor rotation and corresponds in terms of absolute value to the gravitational contribution.

13. The method according to claim 9, further comprising observing oscillations of a power generated by the generator, and wherein comparing the current oscillations in the generated power with the current limit comprises:
filtering the generated power to eliminate wind-excited oscillations, and/or compensating power changes induced by controlling the wind power installation.

14. The method according to claim 9, further comprising observing oscillations of a rotational speed of the rotor, and wherein comparing the current rotational speed of the rotor with the current limit comprises filtering the observed rotational speed to eliminate wind-excited oscillations.

15. The method according to claim 1, further comprising:
determining an expected operating load of the wind power installation during normal operation,
comparing the expected operating load of the wind power installation with a measured actual load of the wind power installation and
adjusting the parametrized limit based on the comparison.

16. The method according to claim 15, wherein the adjustment of the parametrized limit comprises:
increasing the parametrized limit by a predetermined increase factor when the parametrized limit has been exceeded, and/or
reducing the parametrized limit by a predetermined reduction factor when the parametrized limit has not been exceeded over a predetermined period of time.

17. The method according to claim 1, wherein the operating the wind power installation based on the comparison comprises:
detecting an unusual oscillation event when the current value of the observed oscillation overshoots or undershoots the current limit, and
communicating the detected unusual oscillation event by way of SCADA.

18. The method according to claim 1, wherein the at least one current ambient parameter is an ambient parameter that is indicative for the current incident flow.

19. A wind power installation comprising a controller, wherein the controller is configured to implement the method according to claim 1.

20. A wind farm comprising a plurality of wind power installations according to claim 19.
